(19) United States
(12) Patent Application Publication
(10) Pub. No.: US 2010/0324877 A1
(43) Pub. Date: Dec. 23, 2010

(54) DEVICE PROPERTY OUTPUT APPARATUS AND COMPUTER READABLE MEDIUM COMPRISING PROGRAM CODE FOR OUTPUTTING DEVICE PROPERTY

(75) Inventor: Hideyuki Kawakita, Kawasaki-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/727,578

(22) Filed: Mar. 19, 2010

(30) Foreign Application Priority Data
Jun. 23, 2009 (JP) 2009-148905

(51) Int. Cl. G06G 7/62

(52) U.S. Cl. 703/13

(57) ABSTRACT

A device property output apparatus includes an input unit configured to accept measured data of a device property, target data of the device property, and first simulation data indicating a simulation result of the device property, a reference data generator configured to generate reference data indicating a relationship between the measured data and the target data, a converter configured to conduct scale conversion of the first simulation data to generate second simulation data based on the reference data, and an output unit configured to output the second simulation data or auxiliary information indicating a difference between the target data and the second simulation data.

### CROSS-REFERENCE TO RELATED APPLICATION

This application is based upon and claims the benefit of priority from the prior Japanese Patent Application No. 2009-148905, filed on Jun. 23, 2009; the entire contents of which are incorporated herein by reference.

### BACKGROUND OF THE INVENTION

1. Field of the Invention

The present invention relates to a device property output apparatus and a computer readable medium comprising a computer program code for outputting a device property, particularly to a device property output apparatus and a computer readable medium comprising a computer program code for outputting the device property that are used in a device property simulation.

2. Related Art

Ordinarily, a device property (for example, MOSFET (Metal Oxide Semiconductor Field Effect Transistor) property) is expressed using a linear-scale graph or a log (logarithm)-scale graph. When the linear scale or the log-scale is used, because a variation (that is, gradient) becomes extremely steep in a partial region of the device property, a scale that can easily be seen by a user depends on the region of the device property. For example, in a current-voltage property (hereinafter referred to as “I-V property”) of MOSFET, the log scale is preferably used when a gate-source voltage is lower than a predetermined threshold voltage Vₜₕ, and the linear scale is preferably used when the gate-source voltage is equal to and higher than the predetermined threshold voltage Vₜₕ.

However, for a specialized application, occasionally, the linear scale and the log scale are not easily seen by the user. For example, although the device property near the threshold voltage Vₜₕ becomes an important factor for an analog application, the linear-scale device property or log-scale device property near the threshold voltage Vₜₕ is not easily seen by the user.

For example, JP-A No. 2007-200290 (Kokai) discloses a method for extracting a parameter of the device property.

However, the parameter extracting method disclosed in JP-A No. 2007-200290 (Kokai) is made in consideration of a comprehensive and quantitative evaluation of a degree of coincidence between a measured value and a calculated value (hereinafter referred to as “simulation result”). Accordingly, when the simulation result is expressed using the linear-scale graph or the log-scale graph irrespective of the simulation result, the linear-scale graph or the log-scale graph is not always easily seen by the user.

That is, conventionally, whether the simulation result is easily seen by the user depends on the variation of the device property.

### BRIEF SUMMARY OF THE INVENTION

According to a first aspect of the present invention, there is provided a device property output apparatus comprising:

an input unit configured to accept measured data of a device property, target data of the device property, and first simulation data indicating a simulation result of the device property;

a reference data generator configured to generate reference data indicating a relationship between the measured data and the target data;

a converter configured to conduct scale conversion of the first simulation data to generate second simulation data based on the reference data; and

an output unit configured to output the second simulation data or auxiliary information indicating a difference between the target data and the second simulation data.

According to a second aspect of the present invention, there is provided a method for outputting a device property, the method comprising:

accepting measured data of a device property, target data of the device property, and first simulation data indicating a simulation result of the device property;

generating reference data indicating a relationship between the measured data and the target data;

conducting scale conversion of the first simulation data to generate second simulation data based on the reference data; and

outputting the second simulation data or auxiliary information indicating a difference between the target data and the second simulation data.

According to a third aspect of the present invention, there is provided a computer readable medium comprising a computer program code for outputting a device property, the computer program code comprising:

accepting measured data of a device property, target data of the device property, and first simulation data indicating a simulation result of the device property;

generating reference data indicating a relationship between the measured data and the target data;

conducting scale conversion of the first simulation data to generate second simulation data based on the reference data; and

outputting the second simulation data or auxiliary information indicating a difference between the target data and the second simulation data.

### BRIEF DESCRIPTION OF THE DRAWINGS

FIG. 1 is a block diagram illustrating a configuration of a device property output apparatus 10 according to an embodiment of the present invention.

FIG. 2 is a block diagram illustrating a functional configuration realized by a processor 14 of FIG. 1.

FIG. 3 is a flowchart illustrating a procedure of the device property output operation according to the embodiment.

FIG. 4 is a schematic diagram illustrating an outline of target data according to the embodiment.

FIG. 5 is a schematic diagram illustrating an outline of reference data according to the embodiment.

FIG. 6 is a schematic diagram illustrating an outline of first simulation data according to the embodiment.

FIG. 7 is a schematic diagram illustrating an outline of second simulation data according to the embodiment.

FIG. 8 is a schematic diagram illustrating an outline of auxiliary information of the second simulation data according to the embodiment.

FIG. 9 is a flow chart illustrating a procedure of a device property output operation according to a modification of the embodiment of the present invention.

### DETAILED DESCRIPTION OF THE INVENTION

An embodiment of the present invention will be described in detail with reference to the drawings.

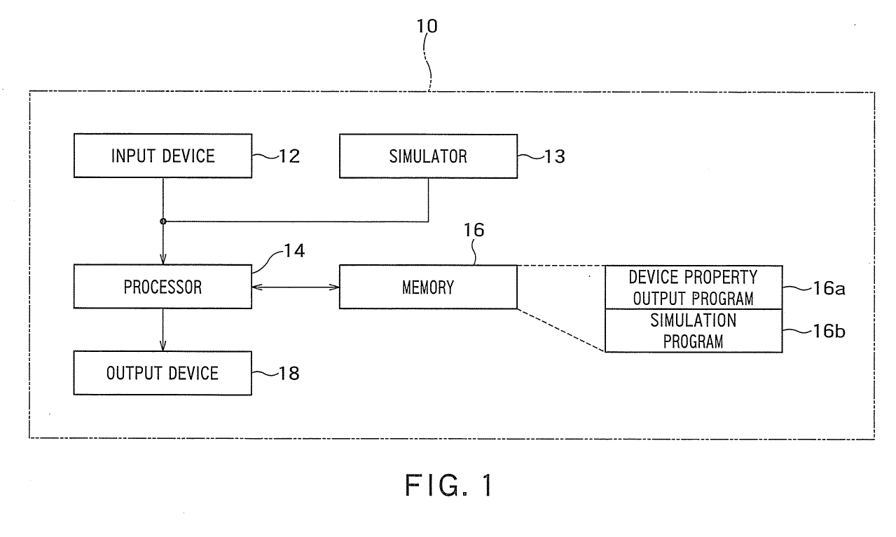

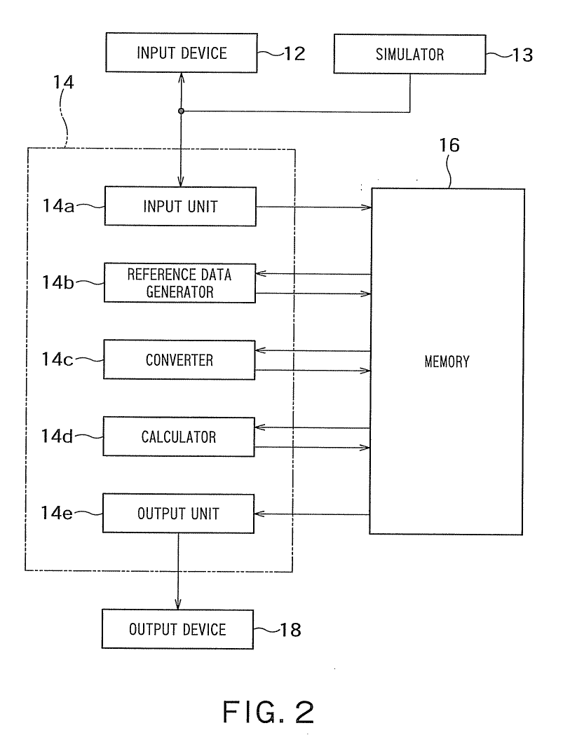

A configuration of a device property output apparatus according to the embodiment will be described below. FIG. 1 is a block diagram illustrating a configuration of a device property output apparatus 10 according to an embodiment of the present invention. FIG. 2 is a block diagram illustrating a functional configuration realized by a processor 14 of FIG. 1.

As illustrated in FIG. 1, the device property output apparatus 10 according to the embodiment includes an input device 12 that is configured to accept a data accept from a user, a simulator 13 that is configured to simulate a device property (for example, current-voltage property), a processor 14 that is configured to realize a function of the device property output apparatus 10, a memory 16 such as a hard disk that is configured to be able to store various kinds of data and programs, and an output device 18 that is configured to supply various kinds of data.

For example, the input device 12 of FIG. 1 is a keyboard, a mouse, or a network interface. When the network interface is used as the input device 12, the input device 12 is connected through a network to a terminal (hereinafter referred to as “external terminal”) that is provided outside the device property output apparatus 10.

The simulator 13 is configured to simulate the device property. For example, the simulator 13 is a SPICE (Simulation Program with Integrated Circuit Emphasis) circuit simulator.

The processor 14 of FIG. 1 starts a device property output program 16a stored in the memory 16 in order to realize functions (an input unit 14a, a reference data generator 14b, a converter 14c, a calculator 14d, and an output unit 14e) of the device property output apparatus 10 of FIG. 2. When the simulator 13 is realized by software, the processor 14 starts a simulation program 16b stored in the memory 16 in order to realize the function of the simulator 13.

The input unit 14a of FIG. 2 is configured to accept measured data indicating a measurement result (measured value) of the device property and target data indicating a target (target value) of the device property from the input device 12, and to accept first simulation data indicating a simulation result of the device property from the simulator 13. The input unit 14a is configured to write the measured data, the target data, and the first simulation data in the memory 16.

The reference data generator 14b of FIG. 2 is configured to generate reference data indicating a relationship between the measured data and the target data. The reference data generator 14b is also configured to obtain the measured data and the target data from the memory 16, and to write the reference data in the memory 16.

The converter 14c of FIG. 2 is configured to conduct scale conversion of the first simulation data to generate second simulation data based on the reference data. A scale used in the second simulation data is difference from a scale used in the first simulation data. The converter 14c is also configured to obtain the reference data and the first simulation data from the memory 16, and to write the second simulation data in the memory 16.

The calculator 14d of FIG. 2 is configured to calculate auxiliary information of the second simulation data, which is used to apply the simulation result. The auxiliary information indicates a relationship between the target data and the second simulation data. The calculator 14d is configured to obtain the target data and the second simulation data from the memory 16, and to write the calculated auxiliary information in the memory 16.

The output unit 14e of FIG. 2 is configured to obtain the second simulation data and the auxiliary information from the memory 16, and to supply the second simulation data and the auxiliary information to the output device 18.

The memory 16 of FIG. 1 is configured to be able to store a device property output program 16a, a simulation program 16b, and various kinds of data used in a device property output operation (described below) therein. The device property output program 16a of FIG. 1 is an application program including plural program codes for realizing the functions of the device property output apparatus 10. The simulation program 16b is an application program for realizing the simulator 13.

For example, the output device 18 of FIG. 1 is a display, a printer, or the network interface. When the network interface is used as the output device 18, the output device 18 is connected to the external terminal through the network. At this point, the output unit 14e transmits data (for example, the second simulation data and the auxiliary information) to the external terminal that is connected through the network.

That is, the input device 12 is an input interface of the device property output apparatus 10. The processor 14 executes the program codes in the device property output program 16a to realize the functions of the device property output apparatus 10. The memory 16 is a database regarding the device property output apparatus 10. The output device 18 is an output interface of the device property output apparatus 10.

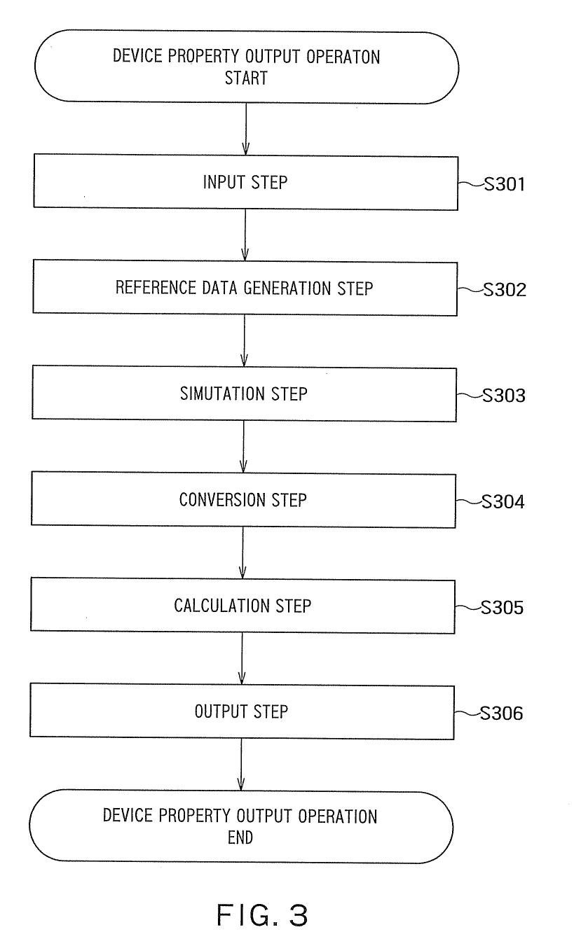

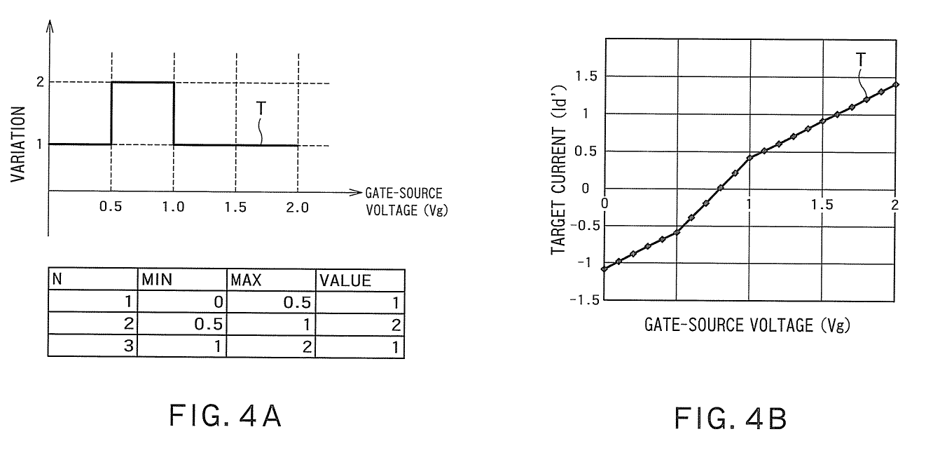

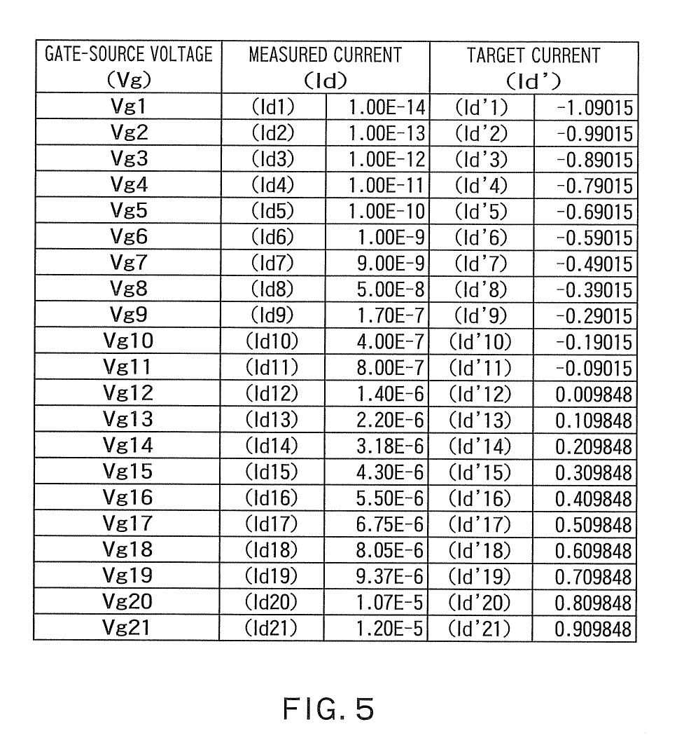

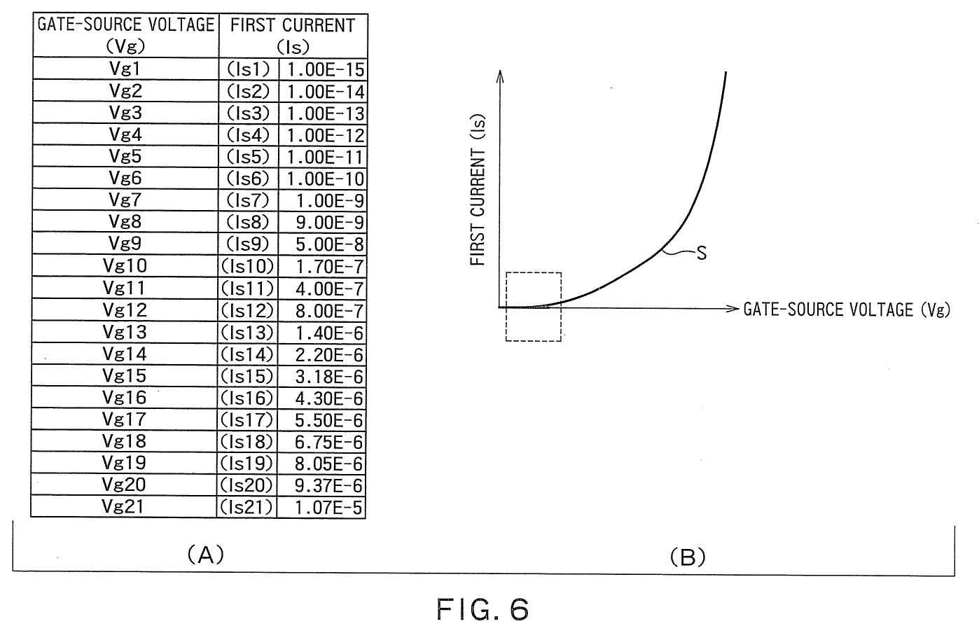

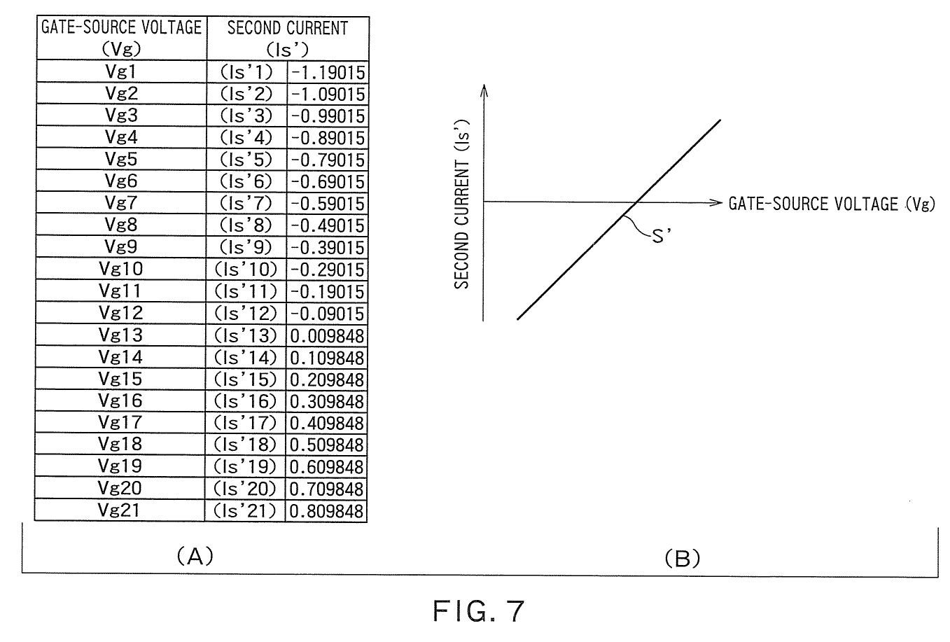

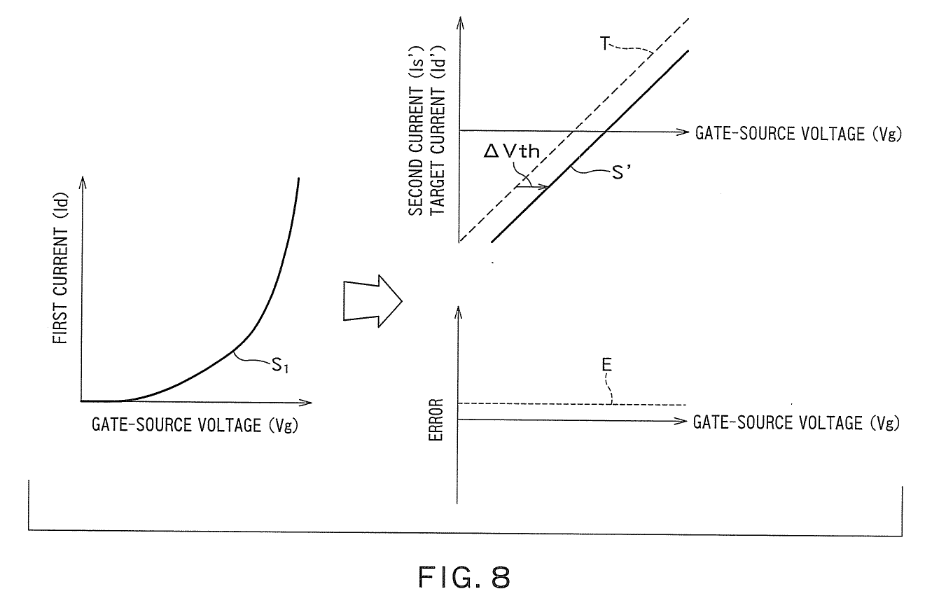

The device property output operation according to the embodiment will be described. FIG. 3 is a flowchart illustrating a procedure of the device property output operation according to the embodiment. FIG. 4 is a schematic diagram illustrating an outline of target data according to the embodiment. FIG. 5 is a schematic diagram illustrating an outline of reference data according to the embodiment. FIG. 6 is a schematic diagram illustrating an outline of first simulation data according to the embodiment. FIG. 7 is a schematic diagram illustrating an outline of second simulation data according to the embodiment. FIG. 8 is a schematic diagram illustrating an outline of auxiliary information of the second simulation data according to the embodiment.

When a user feeds a start command regarding the device property output operation with the input device 12, the processor 14 starts the device property output program 16a in order to start the device property output operation of FIG. 3.

(FIG. 3: Input Step (S301))

The input unit 14a of FIG. 2 obtains the measured data indicating the measured value of current for each voltage and the target data indicating the target value of current for each voltage from the input device 12. Then the input unit 14a writes the measured data and the target data in the memory 16. For example, as illustrated in FIG. 4A, target data T indicates a variation (gradient) in each gate-source voltage (Vg). FIG. 4A illustrates an example of the case in which the user defines the target data. The target data T is data to define an important voltage area which the user values in the I-V property to be checked. In other word, the user can define the important voltage area in such a manner that current variations become large in the important voltage area and become small in a voltage area except for the important voltage area independent of variations of the current and the voltage in the measured data. The target data T means where the user emphasizes a voltage region to be confirmed in the current-voltage property. In other words, the user can define the target data T irrespective of the actual change in current voltage of the measured data such that the change in current becomes large in the emphasized voltage region while the change in current becomes small in the not-emphasized voltage region. In FIG. 4A, assuming that a region of variation of 1 is a standard region, a scale (importance) double that of the standard region is set to a region of variation of 2. That is, the target data T is illustrated by the graph of FIG. 4B. The graph of FIG. 4B corresponds to the measured data one by one.

(FIG. 3: Reference Data Generation Step (S302))

The reference data generator 14b of FIG. 2 obtains the measured data and the target data from the memory 16. Then the reference data generator 14b generates the reference data based on the measured data and the target data. Then the reference data generator 14b writes the generated reference data in the memory 16. For example, as illustrated in FIG. 5, the reference data indicates a measured current (Id) and a target current (Id′) to a gate-source voltage (Vg). A relationship between the measured current (Id) in the reference data and the gate-source voltage (Vg) is the measured data. A relationship between the target current (Id′) in the reference data and the gate-source voltage (Vg) is the target data. That is, reference data generator 14b generates the reference data by correlating the measured current (Id1 to Id21) with the target current (Id′1 to Id′21) in each gate-source voltage (Vg1 to Vg21). In other word, the reference data generator 14b accepts the measured data such as measured current (Id) and the target data such as the target current (Id′), and generates the reference data including a combination of response values of the measured data and the target data. For example, the response value of the measured data is a current value when reference values such as gate-source voltage (Vg1 to Vg21) are aligned with each other. For example, the response value of the target data is a current value defined by the user. Each of response values is generated in accordance with each reference values. The reference data becomes a standard of converting the voltage-current property expressed in terms of a nonlinear function into the voltage-current property expressed in terms of an arbitrary function defined by the user. That is, while the conventional property is expressed by a predetermined linear scale or a predetermined logarithm scale, the measured data is expressed by a dynamic scale in the embodiment so as to become the arbitrarily-defined property expression in consideration of the importance of the user. The scale is the reference data. The reference data may be retained in the form of data correspondence table. Alternatively, the reference data may be retained in the form of function by totally or partially approximating the relationship between the measured current (Id) and the target current (Id′) using a proper function.

(FIG. 3: Simulation Step (S303))

The simulator 13 of FIG. 1 simulates the device property to generate the first simulation data. The first simulation data indicates the simulation result (hereinafter referred to as “first current”) of the current in each voltage. Then the simulator 13 supplies the first simulation data to the input unit 14a of FIG. 2. The input unit 14a obtains the first simulation data from the simulator 13, and writes the first simulation data in the memory 16. For example, as illustrated in FIGS. 6A and 6B, the first simulation data indicates a relationship between the gate-source voltage (Vg) and a first current (Iₛ). In the first simulation data, it is difficult for the user to see the first current value in terms of linear scale in the low voltage (broken line of FIG. 6B).

(FIG. 3: Conversion Step (S304))

The converter 14c of FIG. 2 obtains reference data of FIG. 5 and the first simulation data of FIG. 6A from the memory 16. Then, based on the reference data, the converter 14c converts the first simulation data into the second simulation data expressed in terms of a different scale from the scale of the first simulation data. The converter 14c writes the converted second simulation data in the memory 16. As illustrated in FIGS. 7A and 7B, the second simulation data indicates a relationship between the gate-source voltage (Vg) and a second current (Iₛ′). In the second simulation data, it is easy for the user to see the second current value irrespective of magnitude of the voltage. In other words, the target is set such that the user can easily see the value. The second simulation data is matched with the target data when the simulation data is equal to the measured data.

An example of the conversion step (S304) of FIG. 3 will be described. When the reference data is retained in the form of table as illustrated in FIG. 5, the converter 14c of FIG. 2 converts the first simulation data into the second simulation data by setting a target current (Id′m) correlated with the same value as the first current (Iₛn) in the reference data to the second current (Iₛ′n). More specifically, the first current of Vg6 of FIG. 6A is 1.00E-10 which is Id5 in the measured current of the reference data of FIG. 5. The corresponding target current (Id′5=−0.69015) becomes the second simulation data (Is′6) of Vg6. The converter 14c converts the first current (Iₛ2=1.00E-14) into the second current (Iₛ′2=−1.09015), converts the first current (Iₛ3=1.00E-13) into the second current (Is′3=−0.99015), . . . , and converts the first current (Iₛ21=1.07E-5) into the second current (Iₛ'21=0.809848). Further, on the basis of a relationship between the measured current (Id) and the target current (Id′) in the reference data, the converter 14c extrapolate the second current (Iₛ′) to estimate the second current (Iₛ′1=1.19015) when the gate-source voltage (Vg) is Vg1. As a result, the current-voltage property of FIGS. 7A and 7B is generated. That is, the converter 14c replaces the response value of the first simulation data with the target value where the response value of the first simulation data is coincident with the measured value of the reference data, to convert the first simulation data into the second simulation data. Alternatively, when the measured current (Id) corresponding to the first current (Iₛ) is not included in the reference data, the converter 14c may use the target current (Id′) corresponding to the measured current (Id) which is closest to such the first current (Iₛ) as the second current (Iₛ′), or may interpolate the second current (Iₛ′) on the basis of the target currents (Id′) corresponding to the measured currents (Id) which sandwich such the first current (Iₛ). Furthermore, when such the first current (Iₛ) is out of a range of the measured currents (Id), the converter 14c may extrapolate the second current (Iₛ′) on the basis of one or some of the measured currents (Id), or may eliminate such the first current (Iₛ). In that case, the second current (Iₛ′) corresponding to the first current (Iₛ) is not estimated.

(FIG. 3: Calculation Step (S305))

The calculator 14d of FIG. 2 obtains the target data and the second simulation data from the memory 16. Then the calculator 14d calculates the auxiliary information based on the target data and the second simulation data. The calculator 14d writes the calculated auxiliary information in the memory 16.

A first example of the calculation step (S305) of FIG. 3 will be described. The calculator 14d calculates a difference (Vₜₕ) between the target data and the second simulation data for each of the gate-source voltages (Vg) as the auxiliary information (FIG. 8). In FIG. 8, the calculator 14d calculates a difference (ΔI) between the target current (Id′) and the second current (Iₛ′) for each of the gate-source voltages (Vg), thereby calculating the error of the second simulation data relative to the target data. In FIG. 8, the error is kept constant relative to the gate-source voltage. This means that the error is evenly generated for the importance defined by the user in the whole region, and obviously the error (that is, ampere (A)) of the actual current does not become a constant value. That is, the error can be evaluated irrespective of a measured absolute value by converting the first current into the second current with the reference data. The calculator 14d can calculate the error according to the importance, which is defined by the user, by evaluating the first simulation data corresponding to the measured data based on the reference data.

A second example of the calculation step (S305) of FIG. 3 will be described. The calculator 14d calculates a difference between the gate-source voltage (Vg) corresponding to the target current (Id′) and the gate-source voltage (Vg) corresponding to the second current (Iₛ′) which is equal to such the target current (Id′) for each of the second currents (Iₛ′).

A third example of the calculation step (S305) of FIG. 3 will be described. The calculator 14d calculates a difference between differentiation (that is, target data) of the target current Id′ and differentiation of the second current (Iₛ′) in each of gate-source voltages (Vg), thereby calculating the error of a differentiation property of the simulation data as the auxiliary information. This means that the error of a Gm property of MOSFET is evaluated according to the importance defined by the user. The Gm property is one of important factors in the analog circuit.

(FIG. 3: Output Step (S306))

The output unit 14e of FIG. 2 obtains the second simulation data, the target data, and the auxiliary information from the memory 16, and supplies the second simulation data, the target data, and the auxiliary information to the output device 18. For example, as illustrated in FIG. 8, the output unit 14e combines the second simulation data S′ and the target data T to output the combined data to the output device 18. That is, the target data T of FIG. 8 is a linear function, and is used to define the measured data such that the current (Id) becomes a constant variation (gradient) relative to the gate-source voltage (Vg). The second simulation data S′ of FIG. 8 indicates a curve in which the target data is shifted in parallel. The result can clearly be confirmed, because the calculated differentiation property error becomes zero in the whole voltage region. This means that first simulation data (S of FIG. 6B) has the same shape as the target data T while the threshold voltage Vₜₕ is shifted in an X-axis (voltage) direction by a constant amount. This provides a suggestion for improving the SPICE parameter. That is, it is not necessary to change a parameter having an influence on the Gm property, and it is only necessary to shift the threshold voltage Vₜₕ by a voltage difference with the target data.

The device property output operation of FIG. 3 is ended after the output step (S306).

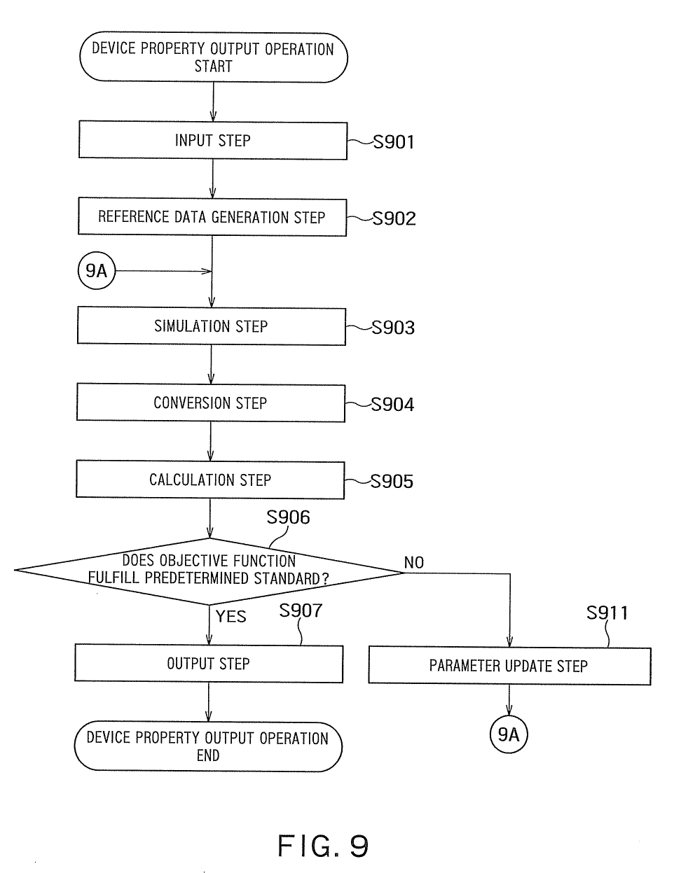

A modification of the embodiment will be described. FIG. 9 is a flow chart illustrating a procedure of a device property output operation according to a modification of the embodiment of the present invention.

When the user feeds the start command regarding the device property output operation with the input device 12, the processor 14 starts the device property output program 16a to start the device property output operation FIG. 9.

(FIG. 9: Input Step (S901))

The input step (S901) is similar to the input step (S301) of FIG. 3.

(FIG. 9: Reference Data Generation Step (S902))

The reference data generation step (S902) is similar to the reference data generation step (S302) of FIG. 3.

(FIG. 9: Simulation Step (S903))

The simulation step (S903) is similar to the simulation step (S303) of FIG. 3.

(FIG. 9: Conversion Step (S904))

The conversion step (S904) is similar to the conversion step (S304) of FIG. 3.

(FIG. 9: Calculation Step (S905))

The calculator 14d of FIG. 2 obtains the target data and the second simulation data from the memory 16. Then the calculator 14d calculates the auxiliary information based on the target data and the second simulation data.

An example of the calculation step (S905) of FIG. 9 will be described. The calculator 14d calculates an objective function based on the target data and the second simulation data. For example, the calculator 14d calculates the error in each gate-source voltage (Vg), and calculates the objective function as the auxiliary information using a square sum of the errors.

(FIG. 9: Step (S906))

When the objective function satisfies a predetermined standard (YES in S906), the flow goes to an output step (S907). When the objective function does not fulfill the predetermined standard (NO in S906), the flow goes to a parameter update step (S911).

(FIG. 9: Output Step (S907))

The output step (S907) is similar to the output step (S306) of FIG. 3.

(FIG. 9: Parameter Update Step (S911))

The calculator 14d calculates an update amount of the parameter (for example, SPICE parameter) using a predetermined optimizing technique (for example, Newton method), generates a new parameter set based on the update amount, and supplies the new parameter set to the simulator 13. After the parameter update step (S911), the flow returns to the simulation step (S903).

The device property output operation of FIG. 9 is ended after the output step (S907).

In the embodiment, the calculator 14d of FIG. 2 and the calculation step (S305) of FIG. 3 may be omitted. In such cases, the output unit 14e supplies the data except for the auxiliary information to the output device 18 in the output step (S306).

In the embodiment, in the reference data generation step (S302) of FIG. 3 or the reference data generation step (S902) of FIG. 9, when the measured data fulfills a predetermined condition, the reference data generator 14b of FIG. 2 may correct the measured data to generate the reference data.

For example, the reference data generator 14b of FIG. 2 may generate an evaluated value of the device property (that is, the device property between two discrete values) that is not included in the measured data. Specifically, it is assumed that pieces of measured data between two points are expressed by a linear function or that pieces of measured data between three points are expressed by a quadratic function. The reference data generator 14b generates a function in which a missing value in the linear function or the quadratic function is interpolated. Therefore, even if the simulation value is matched with the measured value, the corresponding target value can be obtained using the interpolation function.

For example, the reference data generator 14b of FIG. 2 may remove a value (hereinafter referred to as “out-of-value”) beyond a predetermined threshold when the measured data includes the out-of-value. Specifically, when the change in measured current of the measured data is beyond a threshold calculated by a predetermined procedure (for example, decupling an average of variations of plural neighborhood points), the reference data generator 14b removes the measured current as the out-of-value. That is, the measured data becomes a set of measured currents in which the variations are included within the predetermined threshold. Therefore, the influence of the measurement factor can be reduced.

In the embodiment, in the conversion step (S304) of FIG. 3 or the conversion step (S904) of FIG. 9, when the measured data fulfills a predetermined condition, the converter 14c of FIG. 2 may correct the measured data of the reference data to convert the first current (Iₛ) into the second current (Iₛ′).

For example, the converter 14c of FIG. 2 may generate an evaluated value of the device property (that is, the device property between two discrete values) that is not included in the measured data. Specifically, it is assumed that pieces of measured data between two points are expressed by a linear function or that pieces of measured data between three points are expressed by a quadratic function. The converter 14c obtains a missing value in the linear function or the quadratic function by the interpolation. That is, the converter 14c obtains the correction value according to the value of the first simulation data.

Further, in the embodiment, it is explained that the auxiliary information is the difference (ΔI) between the target data and the second simulation data for each of the gate-source voltages (Vg) (see FIG. 8). However, the scope of the invention is not limited to that. The auxiliary information may be the difference between the gate-source voltage (Vg) corresponding to the target current (Id′) and the gate-source voltage (Vg) corresponding to the second current (Iₛ′) which is equal to such the target current (Id′). Also, the auxiliary information may be the difference between a differentiation of the target current (Id′) and a differentiation of the second current (Iₛ′). That, is the auxiliary information may be a difference between a gradient (see FIG. 4A) of the target current (Id′) and a gradient Gm of the second current (Iₛ′). In the other words, the auxiliary information may include at least one of information indicating relationship between the target data and the second simulation data, such as the differences between the currents for each of the gate-source voltages (Vg), the gate-source voltages (Vg) for each of the second currents (Iₛ′), and between the differentiations.

According to the embodiment, the converter 14c converts the first simulation data into the second simulation data based on the reference data. Therefore, the simulation result that is easily seen by the user is supplied irrespective of the variation of the device property. Specifically, as illustrated in FIGS. 6B and 8, the current-voltage property (first simulation data S) expressed by the nonlinear function is converted into the current-voltage property (second simulation data S′) expressed by the linear function based on the target data T. Therefore, the user can easily see the current-voltage property irrespective of the magnitude (device property) of the voltage.

According to the embodiment, even if the measured data and the simulation value are not matched with each other, or even if the measured data includes the out-of-value, the reference data generator 14b complements or corrects the measured data to generate the reference data. Therefore, the first simulation data is properly converted into the second simulation data irrespective of the measured data.

According to the embodiment, even if the measured data and the simulation value are not matched with each other, the converter 14c complements the measured data of the reference data to convert the first current (Iₛ) into the second current (Iₛ′). Therefore, the first simulation data is properly converted into the second simulation data irrespective of the measured data.

According to the embodiment, the output unit 14e supplies the second simulation data, the target data, and the auxiliary information to the output device 18 that is connected to the external terminal through the network. Therefore, the user can confirm the second simulation data using the external terminal that is provided outside the device property output apparatus 10 of the embodiment.

In the embodiment, the calculator 14d calculates the auxiliary information. Therefore, the user can easily apply the second simulation data. In particularly, in the modification of the embodiment, when the objective function calculated by the calculator 14d does not fulfill the standard, the SPCIE parameter is updated until the standard is satisfied. Therefore, the user can easily confirm once the simulation results of the region (region where the user enlarges the scale) corresponding to the optimized SPICE parameter and the whole region.

According to the embodiment, the user can arbitrarily feed the reference data using the input device 12. That is, the user can confirm the simulation result expressed in terms of desired scale. For example, when the user feeds the reference data such that the variation of the device property is partially enlarged, a weight can be added to the simulation result. Therefore, the user can easily see the important region of the simulation result.

What is claimed is:

1. A device property output apparatus comprising:
an input unit configured to accept measured data of a device property, target data of the device property, and first simulation data indicating a simulation result of the device property;
a reference data generator configured to generate reference data indicating a relationship between the measured data and the target data;
a converter configured to conduct scale conversion of the first simulation data to generate second simulation data based on the reference data; and
an output unit configured to output the second simulation data or auxiliary information of the second simulation data.

2. The device of claim 1, wherein the target data is set in accordance with a variation and importance of the device property.

3. The device of claim 1, wherein the reference data comprises a combination of a plurality of response values of the reference data and the target data when the reference values of the reference data and the target data are aligned with each other.

4. The device of claim 1, wherein the converter is configured to replace a response value of the first simulation data with the target data in a case where the first simulation data coincides with the measured value of the reference data to conduct the scale conversion.

5. The device of claim 1, wherein the reference data generator is configured to correct the measured data to generate the reference data when the measured data fulfills a predetermined condition.

6. The device of claim 5, wherein the reference data generator is configured to generate an evaluated value of the device property when the measured data comprises a discrete value.

7. The device of claim 6, wherein the reference data generator is configured to interpolate a missing value in the measured value to generate the evaluated value of the device property.

8. The device of claim 5, wherein the reference data generator is configured to remove an out-of-value beyond a predetermined threshold when the measured data comprises the out-of-value.

9. The device of claim 1, wherein the converter is configured to correct the measured data in the reference data to convert the first simulation data into the second simulation data when the measured data fulfills a predetermined condition.

10. The device of claim 9, wherein the converter is configured to generate an evaluated value of the device property not included in the measured data in the reference data when the measured data comprises a discrete value.

11. The device of claim 10, wherein the converter is configured to interpolate a missing value in the measured value to generate the evaluated value of the device property.

12. The device of claim 1, wherein the output unit is configured to transmit the second simulation data or the auxiliary information to an external terminal connected through a network.

13. The device of claim 1, wherein the auxiliary information comprises at least one of differences between the target data and the second data for each of gate-source voltages, between the gate-source voltages corresponding to the target current and corresponding to the second current which is equal to such the target current, and between a differentiation of the target current and a differentiation of the second current.

14. The device of claim 1, further comprising a calculator configured to calculate an objective function based on the measured data and the second simulation data, wherein
the output unit is configured to further output the objective function.

15. A method for outputting a device property, the method comprising:
accepting measured data of a device property, target data of the device property, and first simulation data indicating a simulation result of the device property;
generating reference data indicating a relationship between the measured data and the target data;
conducting scale conversion of the first simulation data to generate second simulation data based on the reference data; and
outputting the second simulation data or auxiliary information indicating a difference between the target data and the second simulation data.

16. The method of claim 15, wherein the target data is set in accordance with a variation of the device property and importance of the device property.

17. The method of claim 15, wherein the reference data comprises a combination of a plurality of response values of the reference data and the target data when the reference values of the reference data and the target data are aligned with each other.

18. The method of claim 15, wherein in conducting the scale conversion, a response value of the first simulation data with the target data in a case where the first simulation data coincides with the measured value of the reference data to conduct the scale conversion.

19. The method of claim 15, wherein in generating the reference data, the measured data is corrected to generate the reference data when the measured data fulfills a predetermined condition.

20. A computer readable medium comprising a computer program code for outputting a device property, the computer program code comprising:
accepting measured data of a device property, target data of the device property, and first simulation data indicating a simulation result of the device property;
generating reference data indicating a relationship between the measured data and the target data;
conducting scale conversion of the first simulation data to generate second simulation data based on the reference data; and
outputting the second simulation data or auxiliary information indicating a difference between the target data and the second simulation data.
